(19) United States
(12) Patent Application Publication
(10) Pub. No.: US 2023/0223786 A1
(43) Pub. Date: Jul. 13, 2023

(54) ENERGY TIME-SHIFTING USING AQUIFERS

(71) Applicant: William Riley, New Haven, CT (US)

(72) Inventor: William Riley, New Haven, CT (US)

(21) Appl. No.: 17/647,701

(22) Filed: Jan. 11, 2022

(51) Int. Cl. H02J 13/00; H02J 3/00; H02J 3/38; G05B 15/02; F03D 9/00

(52) U.S. Cl. CPC H02J 13/00002; F03D 9/007; G05B 15/02; H02J 3/003; H02J 3/004; H02J 3/381; H02J 2300/22; H02J 2300/28

(57) ABSTRACT

In an energy time-shifting process, an electrical grid is monitored. Based on monitoring the electrical grid, it is determined that one or more criteria are satisfied at a first time. In response to determining that the one or more criteria are satisfied at the first time, water is directed from an aquifer located at a first elevation to a reservoir located at a second elevation. The first elevation is lower than the second elevation. Subsequent to directing the water from the aquifer to the reservoir, water is directed from the reservoir to a turbine generator located at a third elevation. The third elevation is lower than the second elevation and higher than the first elevation. Electrical power is generated using the turbine generated based on the water flowing through the turbine generator. Water is directed from the turbine generator into the aquifer.

### TECHNICAL FIELD

This disclosure relates to systems for storing energy using water directed to and from aquifers based on an electrical demand on an electrical grid.

### BACKGROUND

An aquifer is an underground layer of water-bearing permeable rock, rock fractures, and/or unconsolidated materials (e.g., gravel, sand, or silt) from which groundwater can be extracted. In some implementations, water can be extracted from an aquifer using a water well that extends from the earth’s surface to the aquifer.

Electrical grids rely on a balance between generated power (supply) and consumed power (demand). Dynamic pricing, load shedding, power import/export, power supply regulation, and storage can be used to achieve balance.

### SUMMARY

In one aspect, the present disclosure describes a method that includes monitoring an electrical grid; determining, based on monitoring the electrical grid, that one or more criteria are satisfied at a first time; and, in response to determining that the one or more criteria are satisfied at the first time, directing water from an aquifer located at a first elevation to a reservoir located at a second elevation, wherein the first elevation is lower than the second elevation. The method also includes, subsequent to directing the water from the aquifer to the reservoir, directing the water from the reservoir to a turbine generator located at a third elevation, wherein the third elevation is lower than the second elevation and higher than the first elevation; generating electrical power using the turbine generator based on the water flowing through the turbine generator; and directing the water from the turbine generator into the aquifer.

Implementations of this and other methods described in this disclosure can have any one or more of at least the following characteristics.

In some implementations, monitoring the electrical grid includes monitoring a dynamic price of electricity in the electrical grid, and the one or more criteria include the dynamic price being below a threshold value.

In some implementations, determining that the one or more criteria are satisfied at the first time includes estimating, based on historical data regarding usage of the electrical grid, that a minimum demand for electrical power on the electrical grid occurs at the first time or that a peak supply of electrical power on the electrical grid occurs at the first time.

In some implementations, monitoring the electrical grid includes monitoring a demand for electrical power on the electrical grid over a period of time; and monitoring a supply of electrical power on the electrical grid over the period of time. The one or more criteria include the supply exceeding the demand.

In some implementations, the method includes generating electrical power by at least one of solar power generation or wind power generation. Directing the water from the aquifer to the reservoir includes pumping the water from the aquifer to the reservoir at least partially using power generated by at least one of the solar power generation or the wind power generation.

In some implementations, one or more criteria include a supply of electrical power generated by at least one of the solar power generation or the wind power generation is below a threshold value.

In some implementations, the method includes providing at least a portion of the electrical power generated using the turbine generator to the electrical grid.

In some implementations, directing the water from the reservoir, to the turbine generator, and into the aquifer includes causing the water to flow from the reservoir, to the turbine generator, and into the aquifer without aid of a pump.

In some implementations, directing the water from the aquifer to the reservoir includes directing the water up through a conduit. Directing the water from the reservoir to the aquifer includes directing the water down through the conduit.

In some implementations, directing the water from the reservoir to the turbine generator is performed in response to determining that one or more additional criteria are satisfied at a second time.

In some implementations, monitoring the electrical grid includes monitoring a demand for electrical power on the electrical grid over a period of time; and monitoring a supply of electrical power on the electrical grid over the period of time. The one or more additional criteria include the demand exceeding the supply.

In some implementations, monitoring the electrical grid includes monitoring a demand for electrical power on the electrical grid over a period of time; and monitoring a supply of electrical power on the electrical grid over the period of time. The one or more criteria include a difference between the demand and the supply being less than a threshold level.

In some implementations, determining that the one or more additional criteria are satisfied at the second time includes estimating, based on historical data regarding usage of the electrical grid, that a peak demand for electrical power on the electrical grid occurs at the second time.

Another aspect of this disclosure describes a system. The system includes a renewable power generation system including at least one of solar panels or wind turbines. The system also includes an aquifer located at a first elevation; a reservoir located at a second elevation that is higher than the first elevation; a turbine generator located at a third elevation that is higher than the first elevation and lower than the second elevation; one or more conduits linking the aquifer, the reservoir, and the turbine generator; one or more pumps; and a control system having one or more processors. The control system is configured to perform operations including monitoring an electrical grid, determining, based on monitoring the electrical grid, that one or more criteria are satisfied at a first time, in response to determining that the one or more criteria are satisfied at the first time, and causing the one or more pumps to direct water from the aquifer to the reservoir through the one or more conduits using electrical power generated by the renewable power generation system. The operations also include, subsequent to directing the water from the aquifer to the reservoir, causing the water to flow from the reservoir to the turbine generator through the one or more conduits, causing electrical power to be generated using the turbine generator based on the water flowing through the turbine generator, causing the water to flow from the turbine generator into the aquifer through the one or more conduits, and causing at least a portion of the electrical power generated using the turbine generator to be provided to the electrical grid.

Implementations of this and other systems described in this disclosure can have any one or more of at least the following characteristics.

In some implementations, the operations include, prior to determining that the one or more criteria are satisfied at the first time, causing electrical power generated by the renewable power generation system to be provided to the electrical grid.

In some implementations, monitoring the electrical grid includes monitoring a dynamic price of electricity in the electrical grid, and the one or more criteria include the dynamic price being below a threshold value.

In some implementations, determining that the one or more criteria are satisfied at the first time includes estimating, based on historical data regarding usage of the electrical grid, that a minimum demand for electrical power on the electrical grid occurs at the first time or that a peak supply of electrical power on the electrical grid occurs at the first time.

In some implementations, monitoring the electrical grid includes monitoring a demand for electrical power on the electrical grid over a period of time; and monitoring a supply of electrical power on the electrical grid over the period of time. The one or more criteria include the supply exceeding the demand.

In some implementations, the one or more conduits include one or more pipes encasing one or more wellbores.

In some implementations, the one or more pumps are included in the turbine generator as a pump-turbine generator.

One or more of the implementations described in this disclosure can provide various advantages. For example, implementations according to this disclosure can exploit natural aquifers as portions of pumped hydroelectric energy storage systems, reducing the cost of building and maintaining such systems. By using aquifers to time-shift generated energy, power can be provided to electrical grids at advantageous times to boost income from selling the power and to compensate for supply deficits in the electrical grid. Conversely, power can be used to store energy at advantageous times instead of providing power to the grid, so that power can be generated at later time when it might be more useful, and to compensate for oversupply in the electrical grid.

The details of one or more embodiments are set forth in the accompanying drawings and the description below. Other aspects, features and advantages will be apparent from the detailed description and accompanying drawings, and from the claims.

### BRIEF DESCRIPTION OF THE DRAWINGS

FIGS. 1A and 1B are diagrams illustrating an example of an electrical power system.

FIG. 2 is a diagram illustrating another example electrical power system.

FIG. 3 is a diagram illustrating another example electrical power system.

FIG. 4 is a diagram illustrating another example electrical power system.

FIG. 5 is a diagram illustrating another example electrical power system.

FIG. 6 is a diagram illustrating an example energy storage process.

FIG. 7 is a diagram illustrating an example of a computer system.

### DETAILED DESCRIPTION

This disclosure describes implementations of an electrical power generation and storage system. Some implementations of the electrical power systems are operable to time-shift electrical energy, such as by storing excess generated energy and providing the stored excess energy at a time of greater demand. In some implementations, an electrical power system can be configured to store water extracted from aquifers and subsequently generate power by directing the water back into the aquifer.

To achieve balance across an electrical grid, power generated and provided into the electrical grid should be substantially equal to power consumed from the grid. Too great an imbalance risks grid failure, such as when a frequency of the electrical grid departs too far from its equilibrium point.

Tools to manage electrical grid balance are varied but limited. Among these tools are energy storage and dynamic pricing. In the former, excess generated power is stored as energy instead of being supplied to the electrical grid; this stored energy can later be supplied to the electrical grid, such as when the electrical grid is experiencing a shortfall in supply. Dynamic pricing relies on an established network of power suppliers that can react relatively quickly to changes in the spot pricing to supply more or less power based on spot pricing of wholesale power supplied to the electrical grid. Power suppliers also can react to changes in grid balance, e.g., to changes in overall grid supply compared to overall grid demand. For example, operators of energy storage facilities can choose whether or not to supply power to the electrical grid based on the spot price and based on current grid balance, and operators of flexible power generation facilities, such as coal plants, can have the facilities operate or not operate (or operate at different levels) depending on the spot price and based on current grid balance. Other power generation methods are less flexible. For example, solar power is generated during set periods of sunlight, and wind power is relatively constant and depends on uncontrollable wind characteristics.

Power generation facilities, including but not limited to solar and wind power generation facilities, may generate excess power, meaning power that is generated when the overall electrical grid has more supply than demand. In some cases, excess power is entirely wasted (e.g., dissipated without being constructively used). In some cases, excess power is supplied to the electrical grid, but at a lower spot price than the power would draw at other times, such as when the electrical grid has a deficit of supply compared to demand.

Energy storage facilities can help smooth over transient supply/demand imbalances by acting as temporary repositories for excess power. For example, the excess power can be stored in a battery and subsequently provided to the electrical grid when the power can draw a higher price or when the power can help balance the electrical grid. In pumped hydroelectrical energy storage (PHES), energy is stored as potential energy in water pumped from a lower elevation to a higher elevation. However, although PHES has the capability to store large amounts of energy, PHES is limited by the availability of suitable sites for water storage. Upper and lower storage sites must be arranged in proximity to one another and at appropriate elevations, and the paucity of such site combinations hinders the widespread adoption of PHES. In addition, construction of a new PHES system requires significant capital investment to provide pumping systems, water flow lines, and other flow regulation components.

As described in this disclosure, aquifers can be used as storage sites in PHES systems. Often buried deep beneath the surface, these water-bearing regions of the Earth can have immense spare capacity available to be filled by water from higher elevations such as the surface, given sufficient means for the transfer of water between them. Such transfer, which represents movement of water from a first elevation to a second, lower elevation, can be exploited simultaneously to generate hydroelectric power based on the movement of the water. Complementarily, water from aquifers can be pumped to higher elevations in order to store potential energy that can be extracted subsequently by directing the water back to the aquifers and generating hydroelectric power. Where existing pump and/or storage facilities are already in place, such facilities can be adapted to aquifer-based time-shifting of energy using relatively few resources.

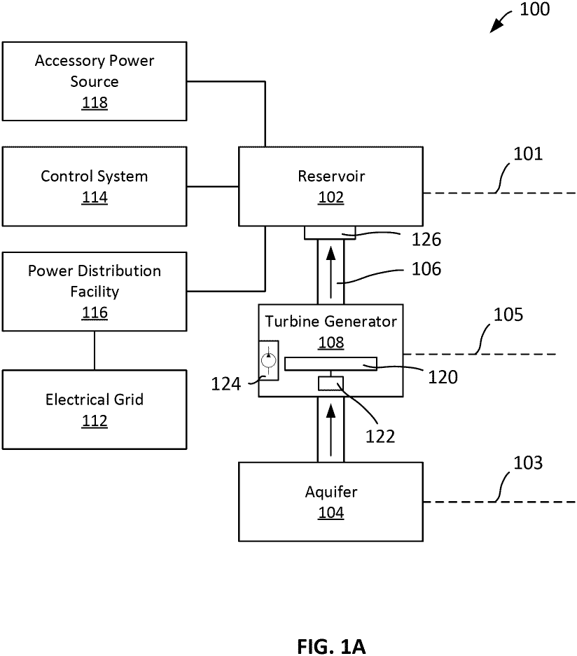

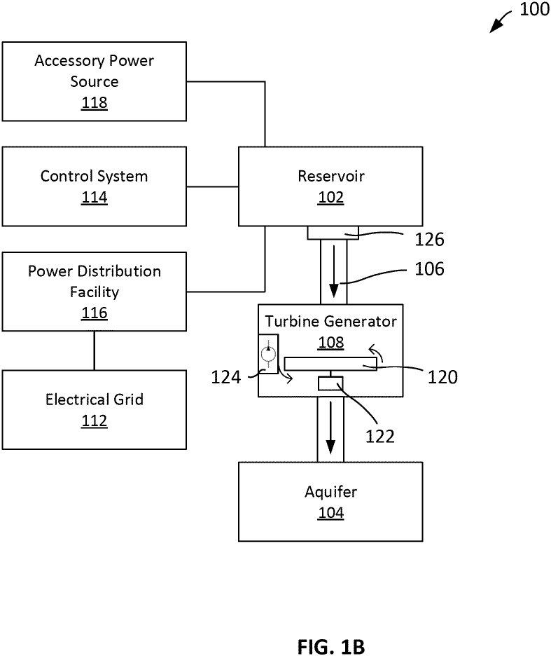

An example electrical power system 100 is shown schematically in FIG. 1A. The electrical power system 100 includes a reservoir 102 and an aquifer 104. The reservoir 102 and the aquifer 104 are in fluid communication with one another via a conduit 106 extending between them. The reservoir 102 is located at a first elevation 101 that is higher than a second elevation 103 at which the aquifer 104 is located. For example, the first elevation 101 can be the surface of the Earth, and the second elevation 103 can be an underground (subterranean) elevation.

The system 100 also includes a turbine generator 108 located in the fluid conduit 106 at a third elevation 105 that is higher than the second elevation 103 of the aquifer 103 and lower than the first elevation 101 of the reservoir 102. The turbine generator 108 converts potential and/or kinetic energy into electrical power. Specifically, as water flows through the conduit 106 from the reservoir 102 to the aquifer 104 (e.g., from a higher elevation to a lower elevation), the turbine generator 108 converts at least a portion of the potential and/or kinetic energy from the flowing water into electrical power. In some implementations, the turbine generator 108 can include one or more turbine or rotor assemblies 120 located in the path of the water flowing through the conduit 106. As the flowing water passes through the turbine generator 108, the flowing water rotates the turbine or rotor assemblies 120. This mechanical motion can be used to actuate one or more components 122 of a dynamo (e.g., a commutator) and/or an alternator (e.g., a magnet or an armature) to produce electrical current.

In this example, the turbine generator 108 includes one or more pumps 124 configured to pump water towards the aquifer 104 (e.g., from the reservoir 102) and/or away from the aquifer 104 (e.g., towards the reservoir 102). For example, in some implementations, the turbine generator 108 can be a pump-turbine or a pump-as-turbine, in which reverse operation of the turbine acts to pump water from the aquifer 104 to the reservoir 102. This implementation can be beneficial, for example, as a pre-existing installation already may have one or more pumps located in conduits extending from the surface of the earth to the aquifer 104. Thus, the turbine generator 108 can be implemented using some or all of those same pumps and conduits, thereby reducing the cost of implementing the electrical power system 100. In some implementations, the one or more pumps 124 are separate from the turbine generator 108 and/or from the one or more turbine or rotor assemblies 120. For example, the one or more pumps 124 can include dedicated positive displacement pumps and/or centrifugal pumps.

In some implementations, the electrical power system 100 includes an accessory power source 118. The accessory power source 118 generates power separately from power generation by the turbine generator 108. For example, the accessory power source 118 can include one or more solar power systems, one or more wind power systems, one or more coal power stations, one or more gas power stations, one or more nuclear power stations, one or more hydropower systems, or a combination thereof. Power generated by the accessory power source 118 is typically provided to the electrical grid 112. However, as described, power generated by the accessory power source 118 sometimes can be used to perform one or more functions of the electrical power system 100, including powering the control system 114 and/or powering the pumps 124 that direct water from the aquifer 104 to the reservoir 102. When the accessory power source 118 includes a source of renewable energy such as solar power, wind power, hydropower, or a combination thereof, the accessory power source 118 can be referred to as a renewable energy generation system.

The electrical power system 100 is connected to an electrical grid 112 by a power distribution facility 116. The power distribution facility 116 can include, for example, one or more electrical transformers to convert electrical power generated by the accessory power source 118 and/or the turbine generator 108 to a suitable current and voltage for transmission, and/or one or more electrical transmission lines to relay the electrical power to a remote entity. The electrical grid 112 with which the power distribution facility 116 is interconnected can be a general power grid (e.g., a municipal or regional power grid) to supply electrical power to one or more consumers (e.g., households, businesses, etc.) across a particular area.

A control system 114 controls operations of the electrical power system 100. For example, the control system 114 can control movement of water between the reservoir 102 and the aquifer 104 (e.g., by controlling the pumps 124 and fluid valves associated with the conduit 106). The control system 114 can also monitor the electrical grid 112, for example, through the power distribution facility 116 and/or through a network connection to receive indicative of electrical grid 112 parameters such as supply, demand, and dynamic power price, and can direct water accordingly, as described in more detail below. The control system 114 can include one or more computer systems on-site (e.g., in proximity to the reservoir 102, accessory power source 118, and/or power distribution facility), one or more remote computing systems such as remote servers communicatively coupled to other portions of the electrical power system 100 (e.g., a cloud computing system), or a combination thereof.

The conduit 106 is configured to convey fluid from one location to another. In some implementations, the conduit 106 includes one or more pipes, tubes, and/or channels for carrying fluid. As an example, the conduit 106 can include one or more pipes encasing one or more wellbores extending between the reservoir 102 and the aquifer 104.

As shown in FIG. 1A, during a first phase of operation of the electrical power system 100, the control system 114 controls the pumps 124 such that water is directed up from the aquifer 104 to the reservoir 102, e.g., via the conduit 106 extending between them. The reservoir 102 stores the water until a second phase of operation. The reservoir 102 can have various forms in different implementations. In some implementations, the reservoir 102 is an artificial reservoir such as an excavated depression that holds water. In some implementations, the reservoir 102 includes a natural body of water, such as an ocean, a lake, or a river (e.g., a dammed portion of a river). In some cases, a freshwater source for the reservoir 102 is preferable, in order to reduce transfer of salt into the aquifer 104. However, some implementations according to this disclosure can include a desalination facility, e.g., a desalination facility integrated into the reservoir 102. Examples of desalination facilities for aquifer-based hydroelectricity generation can be found in U.S. Pat. No. 11,078,649, which is incorporated by reference herein in its entirety.

The aquifer 104 is an underground layer of water-bearing permeable rock, rock fractures, and/or unconsolidated materials (e.g., gravel, sand, or silt) from which groundwater can be extracted. In some implementations, the aquifer 104 is a naturally occurring formation (e.g., a naturally occurring formation below the surface of the earth, with water naturally deposited in the formation).

In some implementations, as part of an energy time-shifting process, transfer of water from the aquifer 104 to the reservoir 102 is performed when one or more conditions are satisfied. These conditions can be related to the electrical grid 112 to which the electrical power system 100 is connected. Transfer of water from the aquifer 104 to the reservoir 102 using the pumps 124 effectively represents storage of the energy used to power the pumps 124; the energy is converted into gravitational potential energy of the transferred water, and the gravitational potential energy can be subsequently converted back into electrical energy by directing water back from the reservoir 102 to the aquifer 104 through the turbine generator 108, as described in more detail below. In some implementations, the energy used to operate the pumps 124 is generated at least in part by the accessory power source 118. In some implementations, the energy used to operate the pumps 124 is obtained at least in part from the electrical grid 112. As power supply and demand ebb and flow in the electrical grid 112, energy storage is more or less favorable, and one or more conditions dictate when water is to be directed from the aquifer 104 to the reservoir 102.

In some implementations, the one or more conditions for storage of energy (transfer of water from the aquifer 104 to the reservoir 102) include a price condition. The electrical grid 112 is monitored (e.g., a market, exchange or clearing house of the electrical grid 112) to determine a dynamic price (spot price) of power sold to the electrical grid 112. If the dynamic price is high, then power generated by the accessory power source 118 is provided to the electrical grid 112. However, if the dynamic price is low, then it might be financially inefficient to provide the generated power to the electrical grid 112; the same amount of energy, provided at a different time, might sell for a significantly higher price. Accordingly, when the dynamic price satisfies a price condition (e.g., is less than a threshold value), power (e.g., power generated by the accessory power source 118) is used to power the pumps 124 to transfer water from the aquifer 104 to the reservoir 102, effectively time-shifting the consumed power to a later time.

In some implementations, the power used to power the pumps 124 (e.g., based on a price condition) is drawn from the electrical grid 112. For example, power is bought at the dynamic price, obtained from the electrical grid 112, and stored by transfer of water from the aquifer 104 to the reservoir 102 using the pumps 124. At a later time, when the dynamic price is higher, the water can be directed from the reservoir 102 to the aquifer 104 to generate power that is then sold back to the electrical grid 112 at the higher dynamic price, implementing price arbitrage by energy storage.

In some implementations, the one or more conditions for storage of energy (transfer of water from the aquifer 104 to the reservoir 102) include a supply/demand condition. Power supply and power demand in the electrical grid 112 are monitored over a period of time. When the supply and demand satisfy a relative condition (e.g., when the supply exceeds the demand), power (e.g., power generated by the accessory power source 118) is used to power the pumps 124 to transfer water from the aquifer 104 to the reservoir 102, effectively time-shifting the consumed power to a later time. This feature can increase an overall efficiency of the electrical grid 112 and electrical power system 100, because excess supply that might otherwise go to waste is instead stored as gravitational potential energy for later exploitation.

In some implementations, the one or more conditions for storage of energy include a timing condition. For example, a future demand for electrical power and/or a future supply of electrical power on the electrical grid 112 are estimated (e.g., based on historical information regarding usage of the electrical grid 112). Based on this estimation, the electrical power system 100 can store energy by transferring water from the aquifer 104 to the reservoir selectively at certain times. This feature can be beneficial, for example, as it enables the electrical power system 100 to store power preemptively (e.g., in anticipation of the supply out-stripping the demand of the electrical grid 112).

In some implementations, the control system 114 can determine, based on historical usage information regarding the electrical grid 112, that demand for electrical power typically exceeds the supply of electrical power during certain times of the day and/or that the demand for electrical power peaks during those times of day. Based on this information, the control system 114 can control the electrical power system 100 to store energy (transfer water from the aquifer 104 to the reservoir 102) before the identified times of day (e.g., at a predetermined time interval before the identified times of day), so that the water can subsequently be transferred from the reservoir 102 to the aquifer 104 and provided to the electrical grid 112 at the identified times of day. Alternatively, or in addition, the control system 114 can determine, based on historical usage information regarding the electrical grid 112, that supply of electrical power typically exceeds demand for electrical power during certain times of day, that the supply of electrical power peaks during those times of day, and/or that the demand for electrical power has a minimum during those times of day. Based on this information, the control system 114 can control the electrical power system 100 to store energy at the identified times of day.

In some implementations, the one or more conditions for storage of energy include a combination of the aforementioned price conditions. For example, a function of the dynamic price, the difference between supply and demand, and/or a time-dependent predicted supply/demand difference can be determined (e.g., a weighted combination of these values), and the function can be tested against a condition to determine whether to transfer water from the aquifer 104 to the reservoir 102.

During a second phase of operation of the electrical power system 100, as shown in FIG. 1B, the control system 114 controls the electrical power system 100 to direct previously-stored water from the reservoir 102 to the aquifer 104 to generate electrical power using the turbine generator 108. For example, the control system 114 can open valves that regulate flow through the conduit 106, to allow water to flow from the reservoir 102 to the aquifer 104 at least partially by force of gravity. As the water flows, the turbine or rotor assemblies 120 are rotated to generate power that can be transferred at least partially to the electrical grid 112 via the power distribution facility 116. In some implementations, the water is allowed to flow under the influence of gravity and without the aid of pumps. This implementation can improve the overall efficiency of power generation by reducing power that must be spent in order to facilitate power generation using the turbine generator 108.

Generation of electrical power using the turbine generator 108 can be performed selectively at specific times to meet the electrical demand on the electrical grid 112. For example, electrical power can be generated using the turbine generator 108 selectively during times of high or peak demand, and not generated, or generated at a lower level, during times of low demand. As another example, electrical power can be generated using the turbine generator 108 selectively during times of low supply (e.g., when the supply of power is unable to meet the demand, or is at least of being unable to meet the demand). This implementation can be useful, for example, as it allows the electrical grid 112 to provide electrical power reliably to each of its users, despite fluctuations in demand over time. This also can be useful, for example, as it enables electrical power to be generated and delivered more efficiently (e.g., by reducing the storage of excess electrical power during times of low demand, which may be electrically inefficient due to power losses during the storage process). As another example, electrical power can be generated using the turbine generator 108 selectively based on the dynamic price of electricity on the electrical grid, so that the generated electrical power can be sold on the electrical grid 112 for a sufficiently high price.

In some implementations, the control system 114 controls the electrical power system 100 to generate electrical power using the turbine generator 108 selectively to mitigate the effects of a temporal displacement between supply and demand due to the electrical grid’s reliance on solar power. For example, the electrical grid’s supply of solar power typically peaks during times of intense sunlight (e.g., during the afternoon). However, demand of electrical power often peaks during a different time of day when the supply of solar power has diminished (e.g., during the early evening). The electrical power system 100 can generate electrical power using the turbine generator 108 selectively (e.g., when the supply of solar power is diminished) to supplement the electrical grid’s supply.

During the second phase of operation, the control system 114 determines, based on monitoring of the electrical grid 112, that one or more trigger criteria have been met (e.g., indicating that power is to be generated using the water in the reservoir 102). In response, the control system 114 causes the water to flow from the reservoir 102, through the turbine generator 108, and into the aquifer 104 (e.g., through the conduit 106 extending between them). In some implementations, this can be performed, at least in part, by releasing water through a valve 126 in fluid communication between the reservoir 102 and the conduit 106, and allowing the water to flow through the turbine generator 108 and into the aquifer 104 predominantly or entirely under the influence of gravity.

At least a portion of the electrical power generated by the turbine generator 108 is provided to the power distribution facility 116. Further, at least a portion of that electrical power can be provided to the electrical grid 112 for use. In some implementations, all or substantially all of the electrical power generated by the turbine generator 108 can be provided to the electrical grid 112. In some implementations, some of the electrical power generated by the turbine generator 108 can be used by the electrical power system 100 to support its operation (e.g., to power the control system 114 and/or power distribution facility 116).

In practice, various trigger criteria can be used to determine when the electrical power system 100 is to generate electrical power using the turbine generator 108. As an example, in some implementations, the control system 114 can determine a demand for electrical power on the electrical grid 1112 over a period of time (e.g., during a particular measurement interval), and determine a supply of electrical power on the electrical grid 112 over the period of time (e.g., an amount of electrical power available to meet the demand). If the demand for electrical power exceeds the supply of electrical power, the electrical power system 100 can direct water from the reservoir 102, through the turbine generator 108, and into the aquifer 104 to generate electrical power. The generated electrical power can be provided to the electrical grid 112 to meet the demand.

As another example, in some implementations, the control system 114 can determine that the difference between the demand for electrical power on the electrical grid 112 and the supply for electrical power on the control system 114 is less than a threshold level. In response, the electrical power system 100 can direct water from the reservoir 102, through the turbine generator 108, and into the aquifer 104 to generate electrical power. The generated electrical power can be provided to the electrical grid 112 for distribution. This implementation can be useful, for example, as it allows the electrical power system 100 to provide extra electrical power to the electrical grid 112 when demand is nearing the supply level (e.g., to reduce the risk of demand exceeding supply due to a subsequent spike in demand and/or a reduction in supply).

For instance, the threshold level can be 10 units of power. When the demand for electrical power is 100 units and the supply for electrical power is 120 units, the electrical power system 100 can refrain from directing water from the reservoir 102, through the turbine generator 108, and into the aquifer 104 (e.g., by closing the valve 126). However, when the demand for electrical power is 115 units and the supply for electrical power is 120 units, the electrical power system 100 can direct water from the reservoir 102, through the turbine generator 108, and into the aquifer 104 to generate electrical power (e.g., by opening the valve 126).

In some implementations, the threshold level can be selected empirically (e.g., selected by an operator of the electrical power system 100 based on experiment or tests). In some implementations, the threshold level can be an absolute value (e.g., expressed in absolute units of power). In some implementations, the threshold level can be a relative value (e.g., expressed as a particular percentage of the demand of electrical power or the supply of electrical power).

As another example, in some implementations, the control system 114 can determine that a price condition of a dynamic power price on the electrical grid 112 is satisfied. For example, the price condition can be that the dynamic price is above a threshold value. In response, the control system 114 causes water to flow from the reservoir 102, through the turbine generator 108, and into the aquifer to generate electrical power.

The electrical power generated using the turbine generator 108 was previously stored as gravitational potential energy by transfer of water from the aquifer 104 to the reservoir 102. Accordingly, the electrical power generation represents time-shifting of energy from a time when it was less useful to supply power to the electrical grid 112 (e.g., when supply outstripped demand and/or when the dynamic price of power on the grid was low) to a time when it is more useful to supply power to the electrical grid 112 (e.g., when demand outstrips supply and/or when the dynamic price of power on the grid is high).

In some implementations, the turbine generator 108 is disposed on or near the bottom end 206 of the conduit 106, e.g., at least 75% of the way from the reservoir 102 to the aquifer 104. This implementation can be useful, for example, as it allows transferred water to acquire a relatively large amount of kinetic energy (e.g., due to its descent down the conduit 106), which may increase the amount of electrical power that can be generated by the turbine generator 108.

In some cases, at least a portion of the electrical power system 100, such as the pumps 124 and/or the conduit 106 might be already in place before the electrical power system 100 is configured for energy storage. In such cases, the existing components can be repurposed for energy storage, reducing the costs of establishing an energy storage facility.

Although configurations of the electrical power system 100 are shown in FIGS. 1A and 1B, these are merely illustrative examples. In practice, the electrical power system 100 can have different arrangements of components, depending on the implementation. Further, in practice, the electrical power system 100 can include more than one of some, or all, of the described components. In some cases, one or more of the described components may be omitted.

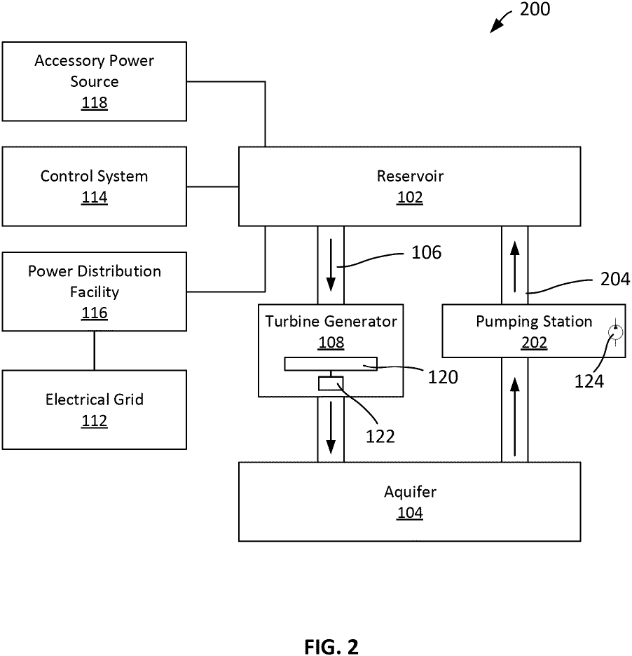

For example, although a single conduit 106 is shown in FIGS. 1A-1B, in practice there can be any number of conduits extending between components of the system 100. As shown in FIG. 2, in some implementations a first conduit 106 is used for flow of water from the reservoir 102 to the aquifer 104, and a second conduit 204 is used for flow of water from the aquifer 104 to the reservoir 102. A pumping station 202 including one or more pumps (as described above) is disposed in or adjacent to the second conduit 204 in order to pump the water from the aquifer 104 to the reservoir 102. This arrangement can simplify component design by allowing the turbine generator 108 and pumping station 202 to be designed and configured specifically for one-way flow of water.

As another example, although a single turbine generator 108 is shown in FIGS. 1A, 1B, and 2, in practice, there may be any number of turbine generators 108 to generate electrical power from flowing water.

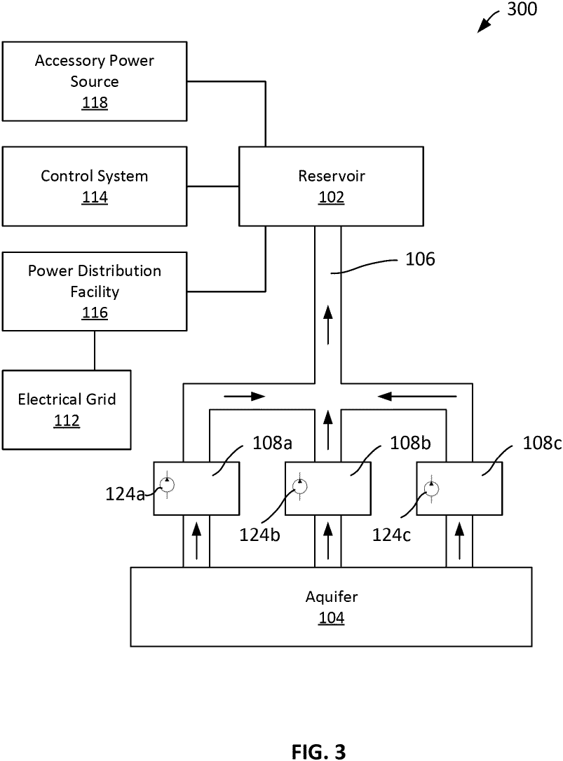

For instance, FIG. 3 shows another example electrical power system 300. In general, each of the components shown in FIG. 3 can operate in a similar manner as the corresponding components shown in FIGS. 1A-1B. As an example, in response to one or more criteria being satisfied, pumps in pumping systems can operate (e.g., powered by the accessory power source 118) to move water from the aquifer 104 to the reservoir 102, thereby storing energy. Further, the system 300 can generate electrical power by subsequently flowing the water from the reservoir 102 to the aquifer 104.

However, in this example, the conduit 106 extends through multiple turbine generators 108a-108c and multiple pump systems 124a-124c (e.g., through a branching, multi-channeled configuration). This configuration enables the use of multiple turbine generators 108a-108c and/or multiple pump systems 124a-124c simultaneously. This implementation can be beneficial, for example, as it spreads the flow of water across multiple turbine generators 108a-108c and/or multiple pump systems 124a-124c, such that the mechanical load across each of the turbine generators 108a-108c is reduced. Further, this implementation enables the electrical power system 300 to store and/or generate electrical power more reliably (e.g., the electrical power system 300 can still store and/or generate electrical power, even if some of the turbine generators 108a-108c and/or pump systems 124a-124c are damaged or disabled). In some implementations, water can be directed selectively to particular turbine generators 108a-108c and/or pump systems 124a-124c (e.g., through the use of valves located along the conduit 106). This implementation can be useful, for example, as it enables one or more of the turbine generators 108a-108c and/or pump systems 124a-124c to be serviced without fully interrupting the flow of water.

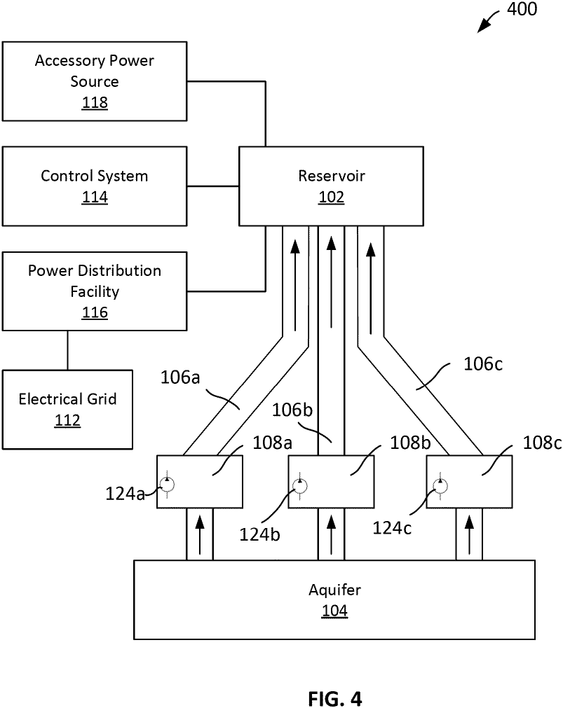

Another example electrical power system 400 is shown in FIG. 4. In general, each of the components shown in FIG. 4 can operate in a manner similar to the corresponding components shown in FIGS. 1A-1B. As an example, in response to one or more criteria being satisfied, pumps in pumping systems can operate (e.g., powered by the accessory power source 118) to move water from the aquifer 104 to the reservoir 102, thereby storing energy. Further, the system 300 can generate electrical power by subsequently flowing the water from the reservoir 102 to the aquifer 104.

However, in this example, the electrical power system 100 includes multiple conduits 106a-106c. Each conduit 106a-106c can extend through a respective turbine generator, a respective pump system, or both. In this example, each conduit 106a-106c extends through a respective turbine generator 108a-108c and a respective pump system 124a-124c. This arrangement allows the use of multiple turbine generators 108a-108c and/or pump systems 124a-124c simultaneously. As with the configuration shown in FIG. 3, this configuration can be beneficial as it spreads the flow of water across multiple turbine generators 108a-108c and/or pump systems 124a-124c, such that the mechanical load across each of the turbine generators 108a-108c and/or pump systems 124a-124c is reduced. Further, this feature can enable the electrical power system 400 to generate electrical power more reliably (e.g., the electrical power system 400 can still generate electrical power, even if some of the turbine generators 108a-108c and/or pump systems 124a-124c are damaged or disabled). In some implementations, water can be directed selectively to particular turbine generators 108a-108c and/or pump systems 124a-124c (e.g., by selectively directing water into particular conduits 106a-106c). This can be useful, for example, as it enables one or more of the turbine generators 108a-108c and/or pump systems 124a-124c to be serviced without fully interrupting the flow of water.

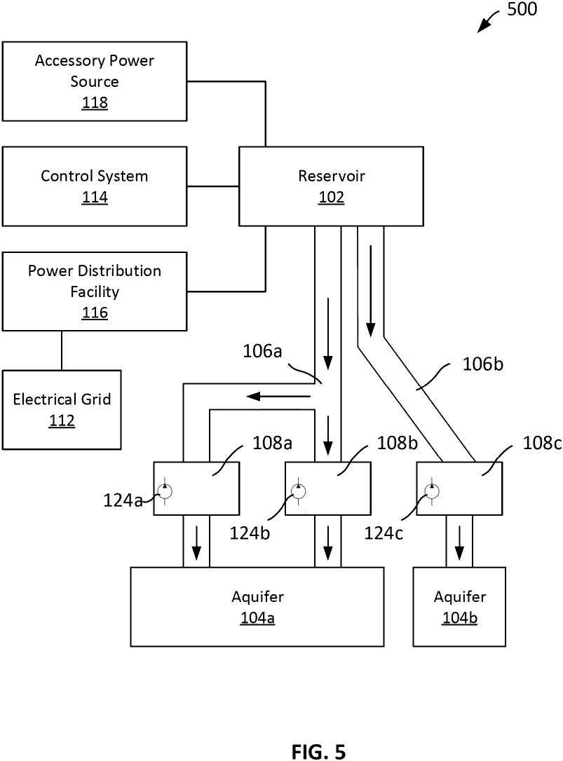

In some implementations, a system 100 includes multiple aquifers. For instance, FIG. 5 shows another example electrical power system 500. In general, each of the components shown in FIG. 5 can operate in a manner similar to the corresponding components shown in FIG. 1. As an example, in response to one or more criteria being satisfied, pumps in pumping systems can operate (e.g., powered by the accessory power source 118) to move water from the aquifers 104a, 104b to the reservoir 102, thereby storing energy. Further, the system 400 can generate electrical power by subsequently flowing the water from the reservoir 102 to the aquifers 104a, 104b.

However, in this example, the electrical power system 500 selectively can pump water from and/or direct water to multiple aquifers 104a and 104b, either simultaneously or sequentially (e.g., one at a time). This can allow the electrical power system 500 to replenish an aquifer and/or extract water stored in an aquifer 104a, 104b independently for each aquifer 104a, 104b. For example, the electrical power system 500 can replenish both aquifers 104a and 104b concurrently (e.g., when both aquifers are depleted). As another example, the electrical power system 500 can replenish the aquifer 104a while extracting water from the aquifer 104b (e.g., when only the aquifer 104a is depleted), or can replenish the aquifer 104b while extracting water from the aquifer 104a. As another example, the electrical power system 500 can extract water from both aquifers 104a and 104b concurrently (e.g., when neither aquifer is depleted). In this manner, the electrical power system 500 can manage the water content of multiple aquifers concurrently and in a flexible manner.

Other conditions for storage of power (transfer from aquifer to reservoir) or generation of power (transfer from reservoir to aquifer) are also within the scope of this disclosure. For example, in some implementations, the control system 114 monitors a supply of electrical power to the electrical grid 112 from the accessory power source 118. If the supply of electrical power from the accessory power source 118 increases above a first threshold level, in response, water can be pumped from the aquifer 104 to the reservoir 102 using at least some of the power generated by the accessory power source 118 (e.g., using the difference in power between the amount of power generated by the accessory power source 118 and the first threshold level). This implementation can be useful, for example, in reducing oversupply of electrical power to the electrical grid 112. As another example, in some implementations, if the supply of electrical power from the accessory power source decreases below a second threshold level, in response, the electrical power generation 100 can direct water from the reservoir 102, through the turbine generator 108, and into the aquifer 104 to generate electrical power. The generated electrical power can be provided to the electrical grid 112 for distribution. This can be useful, for example, in mitigating the effects of a temporal displacement between supply and demand due to the electrical grid’s reliance on solar power and/or other power generated by the accessory power source 118. In some implementations, the first threshold level and/or the second threshold level can be determined empirically (e.g., selected by an operator of the electrical power system 100 based on experiment or tests). Alternatively, the threshold levels can be determined in another manner, e.g., in a machine learning process that is trained to optimize one or more efficiency metrics.

In a manner similar to that described with respect to FIG. 2, the source of saline water 110 is located on the earth’s surface 202 (e.g., a body of water exposed along the earth’s surface, such as an ocean or bay), and water is extracted from the source of saline water 110 by an underground conduit 112. In some implementations, however, the source of saline water 110 can be an underground body of water (e.g., an underground reservoir of saline water beneath the earth’s surface). Further, in some implementations, part or the entirety of the conduit 112 can be above the earth’s surface 202 (e.g., a pipe or tube extending along the earth’s surface).

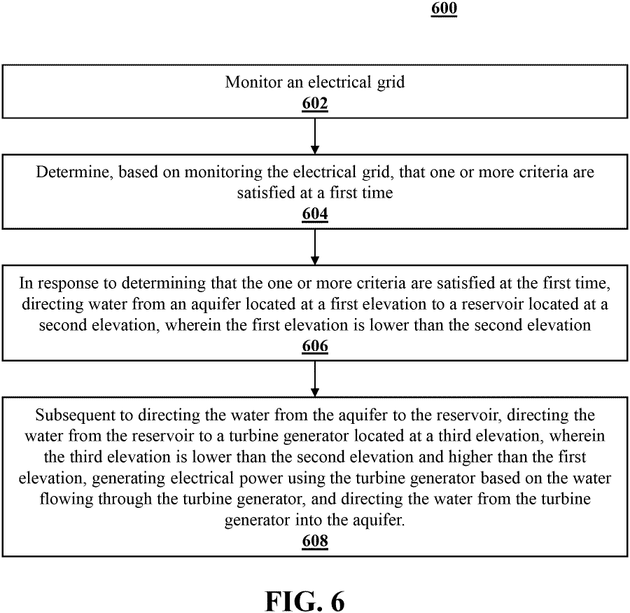

FIG. 6 shows an example process 600 for energy time-shifting according to some implementations of this disclosure. In the process 600, an electrical grid is monitored (602). Based on monitoring the electrical grid, it is determined that one or more criteria are satisfied at a first time (604). In response to determining that the one or more criteria are satisfied at the first time, water is directed from an aquifer located at a first elevation to a reservoir located at a second elevation (606). The first elevation is lower than the second elevation. Subsequent to directing the water from the aquifer to the reservoir, water is directed from the reservoir to a turbine generator located at a third elevation (608). The third elevation is lower than the second elevation and higher than the first elevation. Electrical power is generated using the turbine generated based on the water flowing through the turbine generator. Water is directed from the turbine generator into the aquifer.

Some implementations of the subject matter and operations described in this disclosure can be implemented in digital electronic circuitry, or in computer software, firmware, or hardware, including the structures disclosed in this specification and their structural equivalents, or in combinations of one or more of them. For example, in some implementations, the control system 114 can be implemented using digital electronic circuitry, or in computer software, firmware, or hardware, or in combinations of one or more of them. In another example, the process 600 can be implemented, at least in part, using digital electronic circuitry, or in computer software, firmware, or hardware, or in combinations of one or more of them.

Some implementations described in this specification can be implemented as one or more groups or modules of digital electronic circuitry, computer software, firmware, or hardware, or in combinations of one or more of them. Although different modules can be used, each module need not be distinct, and multiple modules can be implemented on the same digital electronic circuitry, computer software, firmware, or hardware, or combination thereof.

Some implementations described in this specification can be implemented as one or more computer programs, i.e., one or more modules of computer program instructions, encoded on computer storage medium for execution by, or to control the operation of, data processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read only memory or a random access memory or both. A computer includes a processor for performing actions in accordance with instructions and one or more memory devices for storing instructions and data. A computer may also include, or be operatively coupled to receive data from or transfer data to, or both, one or more mass storage devices for storing data, e.g., magnetic, magneto optical disks, or optical disks. However, a computer need not have such devices. Devices suitable for storing computer program instructions and data include all forms of non-volatile memory, media and memory devices, including by way of example semiconductor memory devices (e.g., EPROM, EEPROM, flash memory devices, and others), magnetic disks (e.g., internal hard disks, removable disks, and others), magneto optical disks, and CD-ROM and DVD-ROM disks. The processor and the memory can be supplemented by, or incorporated in, special purpose logic circuitry.

To provide for interaction with a user, operations can be implemented on a computer having a display device (e.g., a monitor, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s client device in response to requests received from the web browser.

A computer system may include a single computing device, or multiple computers that operate in proximity or generally remote from each other and typically interact through a communication network. Examples of communication networks include a local area network (“LAN”) and a wide area network (“WAN”), an inter-network (e.g., the Internet), a network including a satellite link, and peer-to-peer networks (e.g., ad hoc peer-to-peer networks). A relationship of client and server may arise by virtue of computer programs running on the respective computers and having a client-server relationship to each other.

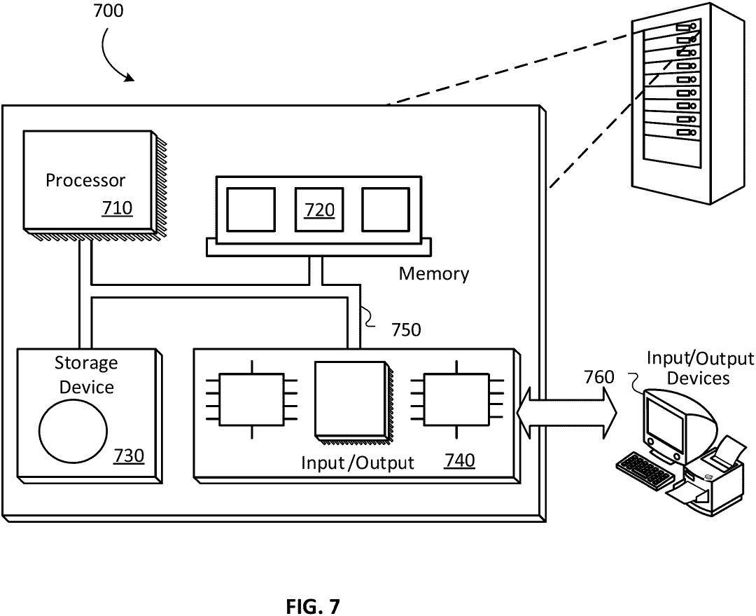

FIG. 7 shows an example computer system 700 that includes a processor 710, a memory 720, a storage device 730 and an input/output device 740. Each of the components 710, 720, 730 and 740 can be interconnected, for example, by a system bus 750. The processor 710 is capable of processing instructions for execution within the system 700. In some implementations, the processor 710 is a single-threaded processor, a multi-threaded processor, or another type of processor. The processor 710 is capable of processing instructions stored in the memory 720 or on the storage device 730. The memory 720 and the storage device 730 can store information within the system 700.

The input/output device 740 provides input/output operations for the system 700. In some implementations, the input/output device 740 can include one or more of a network interface device, e.g., an Ethernet card, a serial communication device, e.g., an RS-232 port, and/or a wireless interface device, e.g., an 802.11 card, a 3G wireless modem, a 4G wireless modem, a 5G wireless modem, etc. In some implementations, the input/output device can include driver devices configured to receive input data and send output data to other input/output devices, e.g., keyboard, printer and display devices 960. In some implementations, mobile computing devices, mobile communication devices, and other devices can be used.

While this specification contains many details, these should not be construed as limitations on the scope of what may be claimed, but rather as descriptions of features specific to particular examples. Certain features that are described in this specification in the context of separate implementations also can be combined. Conversely, various features that are described in the context of a single implementation also can be implemented in multiple embodiments separately or in any suitable subcombination.

A number of implementations have been described. Nevertheless, various modifications may be made without departing from the spirit and scope of the invention. Accordingly, other implementations also are within the scope of the claims.

What is claimed is:

1. A method comprising:
monitoring an electrical grid;
determining, based on monitoring the electrical grid, that one or more criteria are satisfied at a first time;
in response to determining that the one or more criteria are satisfied at the first time, directing water from an aquifer located at a first elevation to a reservoir located at a second elevation, wherein the first elevation is lower than the second elevation; and
subsequent to directing the water from the aquifer to the reservoir,
directing the water from the reservoir to a turbine generator located at a third elevation, wherein the third elevation is lower than the second elevation and higher than the first elevation,
generating electrical power using the turbine generator based on the water flowing through the turbine generator, and
directing the water from the turbine generator into the aquifer.

2. The method of claim 1, wherein monitoring the electrical grid comprises monitoring a dynamic price of electricity in the electrical grid, and
wherein the one or more criteria comprise the dynamic price being below a threshold value.

3. The method of claim 1, wherein determining that the one or more criteria are satisfied at the first time comprises estimating, based on historical data regarding usage of the electrical grid, that a minimum demand for electrical power on the electrical grid occurs at the first time or that a peak supply of electrical power on the electrical grid occurs at the first time.

4. The method of claim 1, wherein monitoring the electrical grid comprises:
monitoring a demand for electrical power on the electrical grid over a period of time; and
monitoring a supply of electrical power on the electrical grid over the period of time,
wherein the one or more criteria comprise the supply exceeding the demand.

5. The method of claim 1, comprising generating electrical power by at least one of solar power generation or wind power generation,
wherein directing the water from the aquifer to the reservoir comprises pumping the water from the aquifer to the reservoir at least partially using power generated by at least one of the solar power generation or the wind power generation.

6. The method of claim 5, wherein the one or more criteria comprise a supply of electrical power generated by at least one of the solar power generation or the wind power generation is below a threshold value.

7. The method of claim 1, comprising:
providing at least a portion of the electrical power generated using the turbine generator to the electrical grid.

8. The method of claim 1, wherein directing the water from the reservoir, to the turbine generator, and into the aquifer comprises causing the water to flow from the reservoir, to the turbine generator, and into the aquifer without aid of a pump.

9. The method of claim 1, wherein directing the water from the aquifer to the reservoir comprises directing the water up through a conduit, and wherein directing the water from the reservoir to the aquifer comprises directing the water down through the conduit.

10. The method of claim 1, wherein directing the water from the reservoir to the turbine generator is performed in response to determining that one or more additional criteria are satisfied at a second time.

11. The method of claim 10, wherein monitoring the electrical grid comprises:
monitoring a demand for electrical power on the electrical grid over a period of time; and
monitoring a supply of electrical power on the electrical grid over the period of time,
wherein the one or more additional criteria comprise the demand exceeding the supply.

12. The method of claim 10, wherein monitoring the electrical grid comprises:
monitoring a demand for electrical power on the electrical grid over a period of time; and
monitoring a supply of electrical power on the electrical grid over the period of time,
wherein the one or more criteria comprise a difference between the demand and the supply being less than a threshold level.

13. The method of claim 10, wherein determining that the one or more additional criteria are satisfied at the second time comprises estimating, based on historical data regarding usage of the electrical grid, that a peak demand for electrical power on the electrical grid occurs at the second time.

14. A system comprising:
a renewable power generation system comprising at least one of solar panels or wind turbines;
an aquifer located at a first elevation;
a reservoir located at a second elevation that is higher than the first elevation;
a turbine generator located at a third elevation that is higher than the first elevation and lower than the second elevation;
one or more conduits linking the aquifer, the reservoir, and the turbine generator;
one or more pumps; and
a control system having one or more processors, the control system configured to perform operations comprising:
monitoring an electrical grid,
determining, based on monitoring the electrical grid, that one or more criteria are satisfied at a first time,
in response to determining that the one or more criteria are satisfied at the first time, causing the one or more pumps to direct water from the aquifer to the reservoir through the one or more conduits using electrical power generated by the renewable power generation system, and
subsequent to directing the water from the aquifer to the reservoir,
causing the water to flow from the reservoir to the turbine generator through the one or more conduits,
causing electrical power to be generated using the turbine generator based on the water flowing through the turbine generator,
causing the water to flow from the turbine generator into the aquifer through the one or more conduits, and
causing at least a portion of the electrical power generated using the turbine generator to be provided to the electrical grid.

15. The system of claim 14, wherein the operations comprise:
prior to determining that the one or more criteria are satisfied at the first time, causing electrical power generated by the renewable power generation system to be provided to the electrical grid.

16. The system of claim 14, wherein monitoring the electrical grid comprises monitoring a dynamic price of electricity in the electrical grid, and
wherein the one or more criteria comprise the dynamic price being below a threshold value.

17. The system of claim 14, wherein determining that the one or more criteria are satisfied at the first time comprises estimating, based on historical data regarding usage of the electrical grid, that a minimum demand for electrical power on the electrical grid occurs at the first time or that a peak supply of electrical power on the electrical grid occurs at the first time.

18. The system of claim 14, wherein monitoring the electrical grid comprises:
monitoring a demand for electrical power on the electrical grid over a period of time; and
monitoring a supply of electrical power on the electrical grid over the period of time,
wherein the one or more criteria comprise the supply exceeding the demand.

19. The system of claim 14, wherein the one or more conduits comprise one or more pipes encasing one or more wellbores.

20. The system of claim 14, wherein the one or more pumps are included in the turbine generator as a pump-turbine generator.
